(19) United States
(12) Patent Application Publication
(10) Pub. No.: US 2019/0272743 A1
(43) Pub. Date: Sep. 5, 2019

(54) Safe Stop Surveillance System

(71) Applicant: Gregory D'Oliveira Henry, West Orange, NJ (US)

(72) Inventor: Gregory D'Oliveira Henry, West Orange, NJ (US)

(21) Appl. No.: 16/290,927

(22) Filed: Mar. 3, 2019

Related U.S. Application Data
(60) Provisional application No. 62/638,610, filed on Mar. 5, 2018.

(51) Int. Cl. G08G 1/017; H04W 4/40; G06K 9/32; B64C 39/02

(52) U.S. Cl. CPC G08G 1/017; H04W 4/40; B64C 2201/126; B64C 39/024; G06K 9/325

(57) ABSTRACT

The present invention provides an enhanced surveillance and wireless communication technology for police vehicle, in particular when the police vehicle is involved in a traffic stop. The invention is installed in a police vehicle and communicates wirelessly with a motorist in his or her vehicle during a traffic stop. The invention causes the wireless communication between the police vehicle and a motorist's vehicle once the technology is activated by the police vehicle. The invention can and will be use with other existing police communication and surveillance technologies. The invention is designed to be installed in a police vehicle as hardware and software programs, without any interference with existing communication devices. The wireless communication signal can only be activated and deactivated by the police officer of an equipped vehicle when needed.

### PRIORITY

This application claims domestic benefit from pending provisional application No. 62/638,610 filed on Mar. 5, 2018.

### FIELD OF INVENTION

The present invention relates to the field of law enforcement safety and operations, specifically for communication through the use of advance wireless and/or Bluetooth technologies, as well as tracking and monitoring officers or field agents.

### BACKGROUND

Annually, approximately 30 plus officers and civilians are killed during traffic stops. Police departments are unable to provide adequate safety and protection for their officers and the motorists during routine or suspicious traffic stops.

Adding some new advance communications, scanning, tracking and monitoring technologies would be very beneficial to the police officer's patrol vehicles, especially during traffic stops. A method for a wireless and or Bluetooth communication system to allow police officers and motor vehicle operators to communicate wirelessly has been addressed in more than one prior patent. However, those prior patents are recognized as methods of social communication. Current wireless communication and monitoring technology designs and functions may be useful, but are not implemented in an efficient manner.

U.S. Pat. No. 6,518,881 discloses the use of two-way radio communications as a means for delivering audio, video, graphic, text and positioning information. U.S. Pat. No. 8,793,383 discloses a network service where upon a user's request the network service transfers a real-time communication session between a first user and a second user to a third user.

There are also other two-way communication technologies which are disclosed in U.S. Pat. Nos. 6,952,164 and 8,009,844. All of these prior art patents disclose technologies relevant to the present invention, which presents a unique combination of several existing technologies.

Some of the existing equipment and/or technologies implemented in the present invention include: Automatic license plate reader U.S. Pat. Nos. 7,504,965, and 6,433,706); Vehicle information dispatcher (U.S. Pat. Nos. 6,580,367 and 7,738,856); Facial recognition software (U.S. Pat. Nos. 8,457,367 and 9,117,109); Emergency response system (U.S. Pat. No. 8,412,254); Vehicle full-body X-ray (U.S. Pat. No. 8,041,005); and Electronic distribution of citations (U.S. Pat. No. 9,552,724)

### SUMMARY OF THE INVENTION

The invention herein presented is a new combination of known technologies. The invention works across existing equipment platforms in law enforcement vehicles. The invention utilizes existing wireless communication technologies to communicate externally with a motorist in his or her vehicle. Components or features for making the two devices communicate as needed when required by a police officer in a patrol vehicle, can be added to automobile wireless or Bluetooth communication systems.

The present invention represents a dynamic improvement to existing wireless communication technologies. The invention utilizes standard two-way mobile communications allowing a police officer and a motorist in a traffic stop situation to communicate wireles sly. An advantage of this wireless communication provides a means to reduce confrontation between a police officer and a motorist during a traffic stop.

This new police wireless communication and safety invention is brought about through the application of additional advance wireless communication technical features. These features are designed to be installed and operate with existing mobile wireless technologies in a police vehicle. The wireless communication is initiated from the police vehicle to a stopped motorist vehicle using existing wireless devices. The wireless communication signal from the police officer's communication device is then used to activate the wireless technologies in the motorist's vehicle.

A preferred embodiment of the invention uses conventional two-way wireless audio electronic circuitry, that communicates through pairing. The wireless communication system in the police vehicle will initiate communication with the motorist's wireless phone or an installed voice communication system in the motorist vehicle. This wireless communication system will allow voice communications as is known in the art.

Allowing the police officer to communicate with the motorist without the officer having to leave the safety of the police vehicle will prevent the officer from risk of injury from the motorist, a passenger in the motorist's vehicle, passing vehicles, or other external conditions, such as weather. Similarly, the wireless communication can prevent the motorist from accidental injury from the police officer. The wireless communication between the police officer and the motorist reduces the need for any physical interaction between the police officer and the stopped motorist, unless absolutely necessary.

For a motorist vehicle which does not have an installed wireless communication system, the invention will allow for wireless communication with an available mobile phone in the possession of the motorist or other occupants of the motorist's vehicle during the traffic stop.

The wireless communication software of this new invention preferably will include advanced security encryption features, to prevent unauthorized access by unauthorized personnel. Advance security features are desirable, because the inventive wireless communication technology is designed to be used in conjunction with other existing law enforcement equipment and or other wireless communication technologies.

### BRIEF DESCRIPTION OF THE DRAWINGS

FIG. 1 is a block diagram of the present invention.

FIG. 2 is a block diagram of the license plate reader component of the invention.

FIG. 3 is a block diagram of the scanner component of the invention.

FIG. 4 is a block diagram of the drone component of the invention.

FIG. 5 is a block diagram showing multiple units of the invention.

FIG. 6 is a block diagram of the citation component of the invention.

FIG. 7 is a block diagram of the data upload function of the invention.

### DETAILED DESCRIPTION OF THE PREFERRED EMBODIMENT

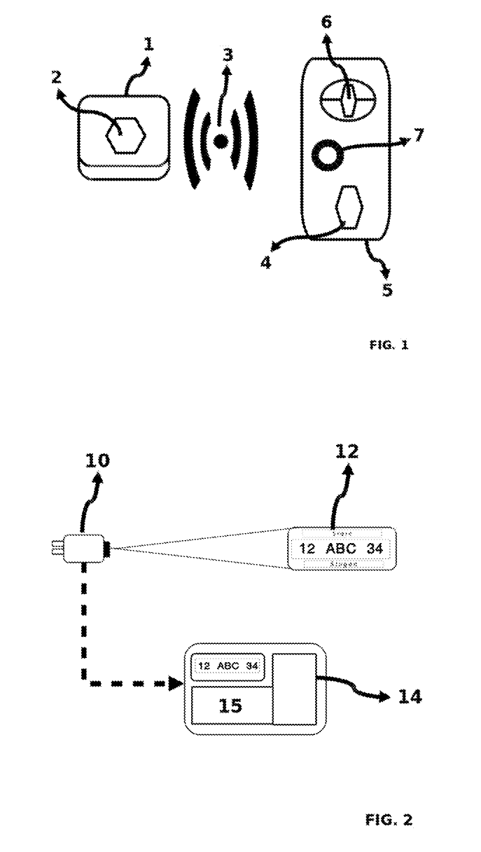

In FIG. 1 police vehicle 1 contains transmission device 2, where transmission device 2 sends and receives communication signal 3. Transmission device 2 communicates through communication signal 3 with motorist device 4, which may be a wireless communication device installed in motorist vehicle 5 or with mobile phone 6, operated by motorist 7.

Once a police officer stops a motorist's vehicle 5, the officer may remain in the police vehicle 1, and use transmission device 2 to send a communication signal 3 to the motorist's vehicle 5. The motorist 7 then accepts the communication on mobile phone 6 or on the motorist's vehicle's wireless communication system 4. Once communications are established between the police vehicle 1 and the motorist vehicle 5, any police business may be conducted from the safety of the two vehicles and the police officer and motorist will be safe in their vehicle.

Using the transmission device 2, the police officer can obtain information from the motorist, as well as advise the motorist of the reason for the traffic stop.

Transmission device 2 comprises display 14. Display 14 is preferably touch sensitive. Transmission device 2 is preferably equipped with a real-time GPS mapping and navigation system for faster and more accurate emergency responding and monitoring. Transmission device 2 also preferably includes a general purpose computer for processing data.

In FIG. 2, license plate reader 10 installed on the police vehicle 1, scans license plate 12 of the motorist's vehicle, and displays the scanned license plate on display 14. Transmission device 2 also sends the scanned license plate data to an external database such as a motor vehicle department or police database, to retrieve stored vehicle and vehicle owner data 15 for viewing on display 14.

After a police officer stopped a motorist's vehicle, the motorist's vehicle's ownership and status will be processed by the data gathered by the license's plate reader. This data is then displayed on the police vehicle's mobile computer system.

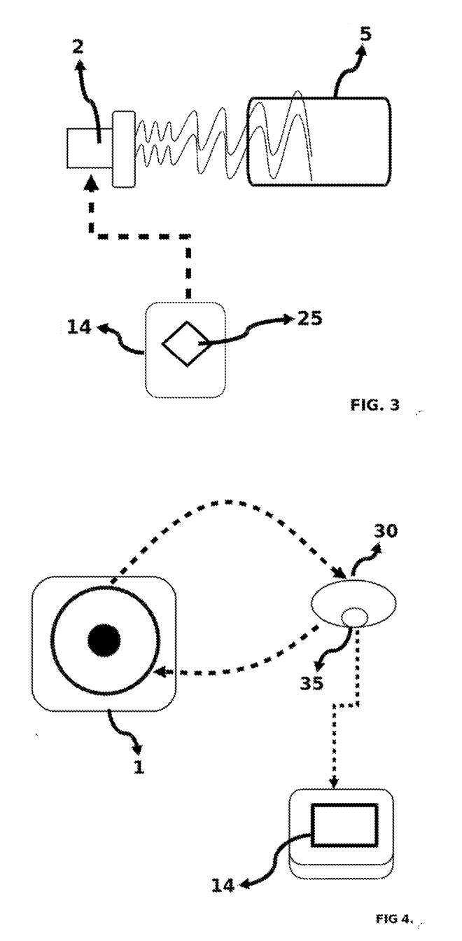

In FIG. 3, scanner 23 scans motorist's vehicle 5. Scanner 23 is preferably mounted on the police vehicle 1. The scan produced by scanner 23 is displayed on display 14 in police vehicle 1. Scanner 23 may scan in one or more technologies, including X-ray, infrared, ultraviolet, or chemical emission.

If the vehicle may be carrying explosives, dangerous chemicals, or hidden illegal drugs or weaponry, the scan can identify such dangerous conditions, without exposing the police officer to risk of harm.

In FIG. 4, drone 30 is shown deployed from police vehicle 1. Drone 30 gathers data using drone surveillance device 35, and transmits the data to display 14 in police vehicle 1. After drone 30 has completed its tasks, it would return to police vehicle 1. Preferably, a police officer in police vehicle 1 controls drone 30, but drone 30 may be controlled from an operator in a remote location, freeing up the officers assigned to police vehicle 1 to conduct other functions.

Drone surveillance device 35 may comprise one or more of a camera, microphone, speaker, or other sensing technology. The camera may be high definition and/or an infrared or X-ray camera, and the microphone and/or speaker may include ultrasonic as well as ordinary acoustic processing capabilities.

During a traffic stop, drone 30 can be deployed to conduct reconnaissance, gathering any additional information that may not be forthcoming by the motorist or occupant(s) of the stopped automobile. Drone 30 may identify hidden occupants in the vehicle, as well as weapons or other hazardous conditions. Images obtained from drone 30 may be processed using facial recognition software to identify the motorist and/or any other occupants of the vehicle, and allow for identification of possible threats to the police officer or possible outstanding warrants.

A plurality of transmission devices 2 installed in different police vehicles may allow for several police officers to work together in an enforcement scenario, or may allow for monitoring the interactions between a police vehicle and a motorist vehicle from a remote location.

Surveillance/Monitoring Phase

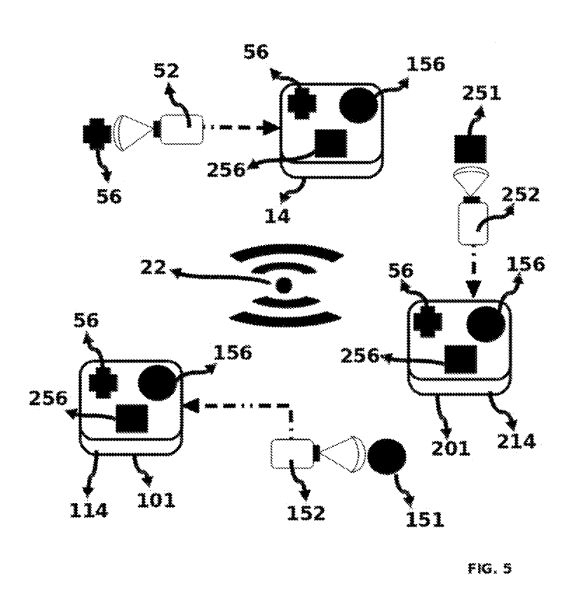

In FIG. 5 target 51 is the subject of camera 52, which is preferably mounted on police vehicle 1. The image of target 51 is transmitted for display on display 14 in police vehicle 1, represented as image 56 in FIG. 5. Image 56 is also transmitted wirelessly to one or more police vehicles 101 and 201, each with displays 114 and 214 respectively. Police vehicles 101 and 201 are likely located remote from police vehicle 1, but may be at the same location, but viewing the location from a different angle. Image 56 is displayed on displays 114 and 214. In a similar manner, target 151 is the subject of camera 152, mounted on police vehicle 101, and target 251 is the subject of camera 252, mounted on police vehicle 201. The transmitted image of target 151 appears as image 156 on displays 14, 114 and 214, and the transmitted image of target 251 appears as image 256 on displays 14, 114 and 214. In this manner, each police vehicle 1, 101 and 201 may see images from the locations of the other vehicles.

Each of the police vehicles 1, 101 and 201 may be located miles away from each other, or just around the corner. This advance surveillance technology is designed to conduct surveillance in a collective fashion, where multiple crimes could be taking place at the same time. This can be useful where a particular incident may require priority resources and attention.

Displays 14, 114 and 214 can show a map of the GPS location of each active police officer's and police vehicles in the emergency response management system. Each police officer can see live video stream of each other's locations and status, displayed on their patrol vehicle's computer screens that are on their police department wireless network.

The nature of the incident may be determined to require priority on multiple police vehicle displays. For high priority incidents, the officers in patrol vehicles 101 and 201 can and will receive information related to police vehicle 1, and if necessary they will have information to respond to support to their fellow officers. This can be helpful if there are multiple situations involving police vehicles happening at the same time, such as if a group of criminals intends to commits a severe crime in one location, but have one of their group stage a minor offense in another location as a distraction.

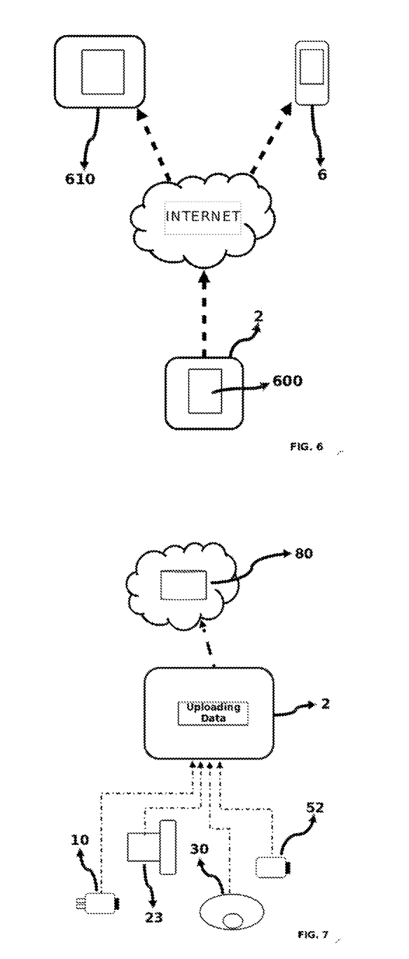

In FIG. 6, transmission device 2 allows a police officer to prepare citation or ticket 600, which can then be transmitted through the internet or cellular network as a text, image, or email message to the motorist's mobile phone 6, or to the motorist's computer 610. The electronic distribution of the citation or ticket can reduce the material costs for paper citations, reduce the processing time of paper citations, and increase accuracy by having the relevant information generated through transmission device 2, with information already of record, such as the motorist's identification and vehicle license plate.

In FIG. 7, transmission device 2 uploads data gathered by the police officer and from one or more of license plate reader 10, scanning device 23, drone 30, and camera 52 through the internet, a cellular network, or dedicated wireless network to a secured server 80.

All data captured from the system is sent to a cloud server, instead of being stored in the police vehicle, and involving a later data transfer. This would reduce the time required by police officers to prepare their various required reports.

The inventive device will be constructed from existing components, and available technologies the cost is predicted to be of minimal value.

Advantages of the present invention include: wireless communication between motorist and officer, greater safety for police officers and motorists, reduced time during routine stops, and reduction of paper used for citations or reports.

While certain novel features of the present invention have been shown and described, it will be understood that various omissions, substitutions and changes in the forms and details of the device illustrated and in its operation can be made by those skilled in the art without departing from the spirit of the invention.

I claim:

1. A method for communication between a police vehicle and a motorist vehicle, the method comprising:
transmission of a first wireless communication signal from a police device in a police vehicle to a motorist's vehicle;
initiating a pairing between a motorist device and the police device;
receiving an image of a motorist from the motorist device;
identification of the motorist's vehicle utilizing a license plate reader of the police vehicle;
dispatching a drone from the police vehicle to surveil the motorist's vehicle, the drone comprising a surveillance system capable of generating surveillance data;
transmission of surveillance data from the drone to the police vehicle; and
transmission of data gathered by the police vehicle to a server.

2. The method of claim 1, further comprising:
communicating with the motorist in the motorist's vehicle from the police vehicle.

3. The method of claim 1, where the transmission of the first wireless communication signal from the police vehicle to the motorist vehicle comprises transmission to one of an installed wireless communication device in the motorist vehicle or a mobile phone;

4. The method of claim 1, further comprising:
using license plate reading technology on the police vehicle, for gathering and verifying motorist's vehicle.

5. The method of claim 1, further comprising:
transmitting a scanning signal from the police vehicle to analyze the motorist's vehicle for any concealed contents.

6. The method of claim 1, further comprising:
identification of the motorist utilizing one of facial recognition technology or artificial intelligent technology.

7. The method of claim 1, further comprising:
analyzing the surveillance data for at least one of driver identification, vehicle contents, and number of occupants.

8. The method of claim 1, further comprising:
transmitting at least one of a citation or violation notice from the police vehicle to at least one of the mobile phone or contact information associated with the driver identification or motorist's vehicle license plate.

9. The method of claim 1, further comprising:
broadcasting real time GPS location and activities of the police vehicle.

10. The method of claim 1, further comprising:
analysis of the motorist's vehicle's license plate.

11. A communication system for a police vehicle allowing for communication with a motorist in a motorist vehicle, the system comprising:
a first transmitter and receiver in the police vehicle, the first transmitter and receiver capable of transmitting and receiving a wireless signal with at least one of a wireless communication device installed in the motorist vehicle or a mobile phone;
a display in the police vehicle;
a general purpose computer;
a license plate reader on the police vehicle;
a drone capable of being deployed from the police vehicle, the drone in wireless communication with the police vehicle; and
a second transmitter and receiver in the police vehicle, the second transmitter and receiver capable of transmitting a second wireless signal with at least one of a police station or a second police vehicle.

12. The communication system of claim 11, further comprising:
at least one of infrared and X-ray vehicle scanning technology is installed in the police vehicle, used to obtain information about the motorist's vehicle.

13. The communication system of claim 12, where the information about the motorist's vehicle includes at least one of the motorist's vehicle's internal contents and a number of persons in the motorist's vehicle.

14. The communication system of claim 11, where the display is capable of displaying information received from the drone.

15. The communication system of claim 11, where the drone comprises at least one of:
an infrared camera, an microphone, a speaker, and a sensor.

16. The communication system of claim 11, further comprising:
a police officer tracking, monitoring and emergency response system, capable of displaying locations of police officers and police vehicles.

17. The communication system of claim 16, where the display is capable of showing locations of a plurality of police vehicles.

18. The communication system of claim 11, further comprising a citation processing and distribution subsystem capable of transmitting at least one of a citation or message to the mobile phone or a notification address associated with the motorist's vehicle.

19. The communication system of claim 11, further comprising a transmitter where all data gathered from the communication system is transmitted to a server located remote from the police vehicle.
